(19) United States
(12) Patent Application Publication
(10) Pub. No.: US 2025/0051594 A1
(43) Pub. Date: Feb. 13, 2025

(54) INKJET INK

(71) Applicant: KYOCERA DOCUMENT SOLUTIONS INC., OSAKA (JP)

(72) Inventor: ARISA MORISHITA, OSAKA (JP)

(21) Appl. No.: 18/797,468

(22) Filed: Aug. 7, 2024

(30) Foreign Application Priority Data
Aug. 9, 2023 (JP) 2023-129999

(51) Int. Cl. C09D 11/30; C09D 11/033

(52) U.S. Cl. CPC C09D 11/30; C09D 11/033

(57) ABSTRACT

An inkjet ink includes: a pigment; a first surfactant; a second surfactant; and an aqueous medium. The first surfactant is a compound represented by the following general formula (I). The second surfactant is a compound represented by the following general formula (II). The aqueous medium includes water and a specific organic solvent. An octanol/water partition coefficient Log K_{ow} of the specific organic solvent is −1.80 or more and −1.00 or less. A content ratio of the first surfactant is 0.03 mass % or more and 0.35 mass % or less. A content ratio of the second surfactant is 0.03 mass % or more and 0.30 mass % or less.

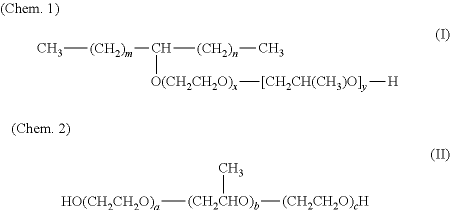

### CROSS-REFERENCE TO RELATED PATENT APPLICATION

This application claims the benefit of Japanese Priority Patent Application JP 2023-129999 filed Aug. 9, 2023, the entire contents of which are incorporated herein by reference.

### FIELD OF THE DISCLOSURE

The present disclosure relates to an inkjet ink.

### BACKGROUND OF THE DISCLOSURE

Some inkjet recording apparatuses use a water-based inkjet ink that includes a pigment and an aqueous medium. From the viewpoint of forming clear images, inkjet inks are desired to have excellent flyability. The flyability of the inkjet ink refers to the ability of the inkjet ink to remain together as one liquid droplet without breaking up from when the ink droplet is ejected from the recording head of the inkjet recording apparatus to when it lands on a recording medium. In the case of inkjet inks with low flyability, the ink droplet breaks up in mid-air before landing on the recording medium and is divided into a main ink droplet (main droplet) and a minute ink droplet (satellite droplet). The main droplet lands a desired position of the recording medium, while the satellite droplet scatters around the main droplet and lands. For this reason, images formed by the inkjet ink with low flyability are less clear

Further, inkjet inks are desired to be capable of forming images with excellent rubfastness (durability against rubbing of the printed inkjet ink). However, there is a trade-off between the flyability and the rubfastness, and it is difficult to achieve both of them.

For example, as a water-based inkjet ink that is capable of forming clear images, an inkjet ink that includes a pigment, an organic solvent, a surfactant, and water, the surfactant including (poly)styrenated polyoxyethylene phenylether sulfate and one or more compounds selected from acetylene glycol and an alkylene oxide adduct of acetylene glycol, has been proposed (Japanese Patent No. 6897949). This inkjet ink is said to be capable of achieving excellent print quality and high print density.

### SUMMARY OF THE DISCLOSURE

However, the inkjet ink disclosed in Japanese Patent No. 6897949 cannot satisfy both the flyability and the rubfastness of a formed image.

In view of the circumstances as described above, it is desirable to provide an inkjet ink that is capable of forming images with excellent rubfastness and has excellent flyability.

According to an embodiment of the present disclosure, there is provided an inkjet ink, including: a pigment; a first surfactant; a second surfactant; and an aqueous medium. The first surfactant is a compound represented by the following general formula (I). The second surfactant is a compound represented by the following general formula (II). The aqueous medium includes water and a specific organic solvent. An octanol/water partition coefficient Log K_{ow} of the specific organic solvent is −1.80 or more and −1.00 or less. A content ratio of the first surfactant is 0.03 mass % or more and 0.35 mass % or less. A content ratio of the second surfactant is 0.03 mass % or more and 0.30 mass % or less.

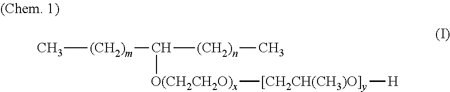

In the general formula (I), m and n each independently represent a number of 0.0 or more and 11.0 or less. m+n is 9.0 or more and 11.0 or less. x represents a number of 1.0 or more and 20.0 or less. y represents a number of 1.0 or more and 10.0 or less.

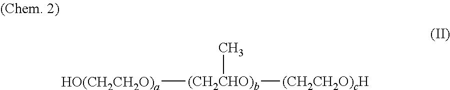

In the general formula (II), a and c each independently represent a number of 0 or more and 25 or less. a+c is 13 or more and 25 or less. b represents a number of 15 or more and 27 or less.

The inkjet ink according to an embodiment of the present disclosure is capable of forming images with excellent rubfastness and has excellent flyability.

These and other objects, features and advantages of the present disclosure will become more apparent in light of the following detailed description of best mode embodiments thereof, as illustrated in the accompanying drawings.

### DETAILED DESCRIPTION OF THE EXEMPLARY EMBODIMENTS

Embodiments of the present disclosure will be described below. Note that in the following, unless otherwise specified, the measured value of the volume median diameter (D₅₀) is a value measured using a dynamic light scattering particle size distribution analyzer (e.g., “Zetasizer (registered trademark) Nano ZS” manufactured by Malvern Panalytical Ltd.).

The measured value of the acid value is a value measured in accordance with “Japanese Industrial Standard (JIS) K0070-1992”, unless otherwise specified.

The measured value of the mass average molecular weight (Mw) is a value measured using gel permeation chromatography (e.g., “HLC-8020GPC” manufactured by TOSOH CORPORATION), unless otherwise specified.

The measured value of the dynamic surface tension is a value measured at 25° C. by a maximum bubble pressure method using a bubble pressure dynamic surface tensiometer (e.g., “BP100” manufactured by KRUSS GmbH, capillary diameter of 0.4 mm), unless otherwise specified.

As the octanol/water partition coefficient Log K_{ow}, a literature value can be used as a reference, unless otherwise specified. Further, Log K_{ow} may be calculated using various types of calculation software (e.g., “Hansen Solubility Parameter in Practice (HSPiP) Ver.5.2.06” (developer: Prof. Steven Abbott, et al.)).

In the present specification, acrylic and methacrylic are collectively referred to as “(meth)acrylic” in some cases. Further, “at least one of A or B” means “A and/or B”.

### [Ink]

An inkjet ink according to an embodiment of the present disclosure (hereinafter, referred to as an ink in some cases) will be described below. The ink according to this embodiment includes: a pigment; a first surfactant; a second surfactant; and an aqueous medium. The first surfactant is a compound represented by the following general formula (I). The second surfactant is a compound represented by the following general formula (II). The aqueous medium includes water and a specific organic solvent. An octanol/water partition coefficient Log K_{ow} (hereinafter, referred to simply as Log K_{ow} in some cases) of the specific organic solvent is −1.80 or more and −1.00 or less. The content ratio of the first surfactant is 0.03 mass % or more and 0.35 mass % or less. The content ratio of the second surfactant is 0.03 mass % or more and 0.30 mass % or less.

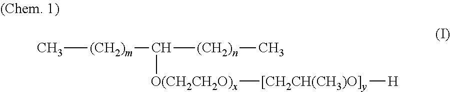

In the general formula (I), m and n each independently represent a number of 0.0 or more and 11.0 or less. m+n is 9.0 or more and 11.0 or less. x represents a number of 1.0 or more and 20.0 or less. y represents a number of 1.0 or more and 10.0 or less.

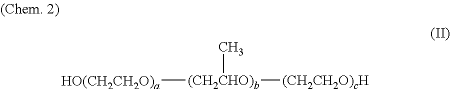

In the general formula (II), a and c each independently represent a number of 0 or more and 25 or less. a+c is 13 or more and 25 or less. b represents a number of 15 or more and 27 or less.

Note that the ink according to this embodiment may include a plurality of types of compounds represented by the general formula (I). In this case, in the general formula (I), m, n, x, and y respectively represent the number average values of m, n, x, and y in the plurality of types of compounds represented by the general formula (I).

Further, the ink according to this embodiment may include a plurality of types of compounds represented by the general formula (II). In this case, in the general formula (II), a, b, and c respectively represent the number average values of a, b, and c in the plurality of types of compounds represented by the general formula (II).

By having the above-mentioned configuration, the ink according to this embodiment is capable of forming images with excellent rubfastness and has excellent flyability. The reasons for this are presumed to be as follows. The surface tension of the ink is very important for flyability. In particular, an ink droplet with high surface tension of the ink immediately after being ejected as an ink droplet from the recording head is capable of remaining together as one liquid droplet. For this reason, the flyability of the ink can be improved by increasing the surface tension (dynamic surface tension) of the ink immediately after being ejected as an ink droplet from the recording head.

Meanwhile, the permeability of the ink to the recording medium is very important for the durability (rubfastness) against the rubbing of the printed ink. The surface tension of the ink when the ink permeates to the recording medium (in other words, the surface tension (dynamic surface tension)) of the ink after the ink droplet lands on the recording medium) is related to the permeability of the ink to the recording medium.

One method of increasing the surface tension (dynamic surface tension) of the ink is to add a highly hydrophobic organic solvent to an aqueous medium. Known inks including the highly hydrophobic organic solvent form an ink droplet with high surface tension when ejected from the recording head. For this reason, known inks including the highly hydrophobic organic solvent have excellent flyability. Meanwhile, the above-mentioned ink droplet maintains the high surface tension even after landing on the recording medium, does not permeate to the recording medium, and remain on the surface of the recording medium. As a result, known inks including the highly hydrophobic organic solvent have insufficient rubfastness of a formed image. Thus, in known inks, there is a trade-off between the flyability and the rubfastness of a formed image.

On the other hand, the ink according to this embodiment includes a specific organic solvent that is an organic solvent having a relatively high hydrophobicity (Log K_{ow} being −1.80 or more and −1.00 or less), a first surfactant (compound represented by the general formula (I)) having a polyoxyalkylenealkylether as the main skeleton, and a second surfactant (compound represented by the general formula (II)) having a polyoxyethylene polyoxypropylene glycol as the main skeleton. Since the ink according to this embodiment uses the specific organic solvent having a relatively high hydrophobicity, i.e., the above-mentioned Log K_{ow}, and includes 0.03 mass % or more and 0.35 mass % or less of the first surfactant and 0.03 mass % or more and 0.30 mass % or less of the second surfactant, the specific organic solvent moderately inhibits the surfactant function of each of the first surfactant and the second surfactant. For this reason, when the ink according to this embodiment is ejected from the recording head, the specific organic solvent inhibits the surfactant function of each of the first surfactant and the second surfactant to form an ink droplet having high surface tension. As a result, the ink according to this embodiment has excellent flyability. Meanwhile, since the ink according to this embodiment includes 0.03 mass % or more and 0.35 mass % or less of the first surfactant and 0.03 mass % or more and 0.30 mass % or less of the second surfactant, the surface tension is sufficiently reduced by the action of the first surfactant and the second surfactant after the ink droplet lands on the recording medium. As a result, the ink according to this embodiment permeates to the recording medium and is capable of forming images with excellent rubfastness. For this reason, the ink according to this embodiment is capable of achieving both the flyability and the rubfastness of a formed image.

The ink according to this embodiment will be described below in more detail. Note that the components described below may be used alone or two or more of them may be used in combination. First, the surface tension (dynamic surface tension) of the ink according to this embodiment will be described below.

### [Dynamic Surface Tension]

The dynamic surface tension of the ink according to this embodiment at the surface age of 10 ms is favorably 38 mN/m or more and 50 mN/m or less, more favorably 42 mN/m or more and 48 mN/m or less. The dynamic surface tension of the ink according to this embodiment at the surface age of 10 ms corresponds to the surface tension immediately after the ink is ejected as an ink droplet from the recording head. By setting the dynamic surface tension at the surface age of 10 ms to 38 mN/m or more, it is possible to optimize the flyability of the ink according to this embodiment. By setting the dynamic surface tension at the surface age of 10 ms to 50 mN/m or less, the ink according to this embodiment is capable of forming images with more excellent rubfastness.

The dynamic surface tension of the ink according to this embodiment at the surface age of 1000 ms is favorably 30 mN/m or more and 38 mN/m or less, more favorably 32 mN/m or more and 38 mN/m or less. The dynamic surface tension of the ink according to this embodiment at the surface age of 1000 ms corresponds to the surface tension after the ink droplet lands on the recording medium. By setting the dynamic surface tension at the surface age of 1000 ms to 30 mN/m or more and 38 mN/m or less, the ink according to this embodiment is capable of forming images with more excellent rubfastness.

### [Composition]

As described above, the ink according to this embodiment includes a pigment, a first surfactant, a second surfactant, and an aqueous medium. The ink according to this embodiment favorably further includes at least one of a pigment coating resin or a surfactant.

### (Pigment)

In the ink according to this embodiment, the pigment forms pigment particles together with, for example, a pigment coating resin. The pigment particle includes, for example, a core including a pigment and a pigment coating resin covering the core. The pigment coating resin is present to be, for example, dispersed in a solvent. From the viewpoint of optimizing the color density, hue, or stability of the ink according to this embodiment, the volume median diameter (D₅₀) of the pigment particles is favorably 30 nm or more and 250 nm or less, more favorably 70 nm or more and 130 nm or less.

Examples of the pigment include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink according to this embodiment, the content ratio of the pigment is favorably 1.00 mass % or more and 10.00 mass % or less, more favorably 4.00 mass % or more and 8.00 mass % or less. By setting the content ratio of the pigment to 1.00 mass % or more, the ink according to this embodiment is capable of more easily forming images with desired image density. Further, by setting the content ratio of the pigment to 15.00 mass % or less, the fluidity of the ink according to this embodiment can be ensured.

### [Pigment Coating Resin]

The pigment coating resin is a resin soluble in an aqueous medium of the ink according to this embodiment. For example, part of the pigment coating resin adheres to the surface of the pigment to optimize the dispersion stability of the pigment in the aqueous medium. Note that part of the pigment coating resin may be free in the aqueous medium without adhering to the surface of the pigment.

As the pigment coating resin, a styrene-(meth)acrylic resin is favorable. The styrene-(meth)acrylic resin includes a repeating unit derived from at least one monomer of (meth)acrylic acid alkylester and (meth)acrylic acid and a styrene unit. Examples of the (meth)acrylic acid alkylester include methyl (meth)acrylate, ethyl (meth)acrylate, propyl (meth)acrylate, and butyl (meth)acrylate. As the styrene-(meth)acrylic resin, a copolymer (X) of styrene, methyl methacrylate, methacrylic acid, and butyl acrylate is favorable. Note that the copolymer (X) is favorably neutralized by an equal amount of a base (e.g., potassium hydroxide and sodium hydroxide).

In all repeating units included in the copolymer (X), the content ratio of the repeating unit derived from styrene is favorably 10.00 mass % or more and 20.00 mass % or less. In all repeating units included in the copolymer (X), the content ratio of the repeating unit derived from methyl methacrylate is favorably 10.00 mass % or more and 20.00 mass % or less. In all repeating units included in the copolymer (X), the content ratio of the repeating unit derived from methacrylic acid is favorably 35.00 mass % or more and 45.00 mass % or less. In all repeating units included in the copolymer (X), the content ratio of the repeating unit derived from butyl acrylate is favorably 25.00 mass % or more and 35.00 mass % or less.

In the ink according to this embodiment, the content ratio of the pigment coating resin is favorably 0.50 mass % or more and 6.00 mass % or less, more favorably 1.50 mass % or more and 4.00 mass % or less. By setting the content ratio of the pigment coating resin to 0.50 mass % or more and 6.00 mass % or less, it is possible to optimize the ejection stability of the ink according to this embodiment.

The acid value of the pigment coating resin is favorably 30 mgKOH/g or more and 200 mgKOH/g or less, more favorably 70 mgKOH/g or more and 130 mgKOH/g or less. By setting the acid value of the pigment coating resin to 30 mgKOH/g or more and 200 mgKOH/g or less, the preservation stability of the ink according to this embodiment can be optimized while further improving the dispersibility of the pigment.

The acid value of the pigment coating resin can be adjusted by changing the amount of the monomer to be used when synthesizing the pigment coating resin. For example, when synthesizing a pigment coating resin, the acid value of the pigment coating resin can be increased by using a monomer (more specifically, acrylic acid, methacrylic acid, or the like) having an acidic functional group (e.g., a carboxy group).

The Mw of the pigment coating resin is favorably 10000 or more and 50000 or less, more favorably 15000 or more and 25000 or less. By setting the Mw of the pigment coating resin to 10000 or more and 50000 or less, it is possible to optimize the image density of a formed image while suppressing an increase in the viscosity of the ink according to this embodiment.

The Mw of the pigment coating resin can be adjusted by changing the polymerization conditions of the pigment coating resin (more specifically, the amount of the polymerization initiator used, the polymerization temperature, the polymerization time, and the like).

In the polymerization of the pigment coating resin, the amount of the polymerization initiator used is favorably 0.001 moles or more and 5 moles or less, more favorably 0.01 moles or more and 2 moles or less, with respect to one mole of the monomer mixture. In the polymerization of the pigment coating resin, for example, the polymerization temperature may be 50° C. or more and 70° C. or less, and the polymerization time may be 10 hours or more and 24 hours or less. Note that the polymerized pigment coating resin is favorably neutralized by an equal amount of a basic compound and then used as a raw material of the ink according to this embodiment. As the basic compound, a hydroxide of an alkali metal ion (e.g., NaOH or KOH) is favorable.

### [First Surfactant]

The first surfactant is the above-mentioned compound represented by the general formula (I). As described above, in the general formula (I), m and n each independently represent a number of 0.0 or more and 11.0 or less. m+n is 9.0 or more and 11.0 or less. x represents a number of 1.0 or more and 20.0 or less. x represents favorably a number of 6.0 or more and 13.0 or less, more favorably a number of 6.0 or more and 8.0 or less or a number of 11.0 or more and 13.0 or less. y represents a number of 1.0 or more and 10.0 or less. y represents favorably a number of 1.5 or more and 6.0 or less, more favorably a number of 1.5 or more and 4.0 or less.

The first surfactant is a nonionic surfactant having a polyoxyalkylenealkylether as the main skeleton. Examples of commercial products of the first surfactant include “SOFTANOL (registered trademark) 30”, “SOFTANOL (registered trademark) 50”, “SOFTANOL (registered trademark) 70”, “SOFTANOL (registered trademark) 90”, and “SOFTANOL (registered trademark) 120” (each of which is “SOFTANOL (registered trademark) M series”) manufactured by NIPPON SHOKUBAI CO., LTD. Further, examples of commercial products of the first surfactant include “SOFTANOL (registered trademark) EP5035”, “SOFTANOL (registered trademark) EP7025”, “SOFTANOL (registered trademark) EP7045”, “SOFTANOL (registered trademark) EP7085”, “SOFTANOL (registered trademark) EP9050”, “SOFTANOL (registered trademark) EP90150”, and “SOFTANOL (registered trademark) EP12030” (each of which is “SOFTANOL (registered trademark) EP series”) manufactured by NIPPON SHOKUBAI CO., LTD.

In the ink according to this embodiment, the content ratio of the first surfactant is 0.03 mass % or more and 0.35 mass % or less, favorably 0.05 mass % or more and 0.15 mass % or less. By setting the content ratio of the first surfactant to 0.03 mass % or more, it is possible to sufficiently reduce the surface tension of the ink after the ink droplet lands on the recording medium. As a result, it is possible to form images with excellent rubfastness. Further, by setting the content ratio of the first surfactant to 0.35 mass % or less, it is possible to form an ink droplet having high surface tension when the ink according to this embodiment is ejected from the recording head. As a result, it is possible to provide an ink having excellent flyability.

### [Second Surfactant]

The second surfactant is the above-mentioned compound represented by the general formula (II). As described above, in the general formula (II), a and c each independently represent a number of 0 or more and 25 or less. a+c is 13 or more and 25 or less. a+c is favorably 16 or more and 22 or less. b represents a number of 15 or more and 27 or less. b favorably represents a number of 18 or more and 24 or less.

The second surfactant is a nonionic surfactant having a polyoxyethylene polyoxypropylene glycol as the main skeleton. Examples of commercial products of the second surfactant include “EPAN (registered trademark) 450” and “EPAN (registered trademark) 710” manufactured by DKS Co. Ltd.

In the ink according to this embodiment, the content ratio of the second surfactant is 0.03 mass % or more and 0.30 mass % or less, favorably 0.05 mass % or more and 0.15 mass % or less. By setting the content ratio of the second surfactant to 0.03 mass % or more, it is possible to sufficiently reduce the surface tension of the ink after the ink droplet lands on the recording medium. As a result, it is possible to form images with excellent rubfastness. Further, by setting the content ratio of the second surfactant to 0.30 mass % or less, it is possible to form an ink droplet having high surface tension when the ink according to this embodiment is ejected from the recording head. As a result, it is possible to provide an ink having excellent flyability.

In the ink according to this embodiment, the total content ratio of the first surfactant and the second surfactant is favorably 0.06 mass % or more and 0.40 mass % or less, more favorably 0.10 mass % or more and 0.33 mass % or less, and still more favorably 0.15 mass % or more and 0.25 mass % or less. By setting the total content ratio of the first surfactant and the second surfactant to 0.06 mass % or more, it is possible to optimize the surface tension of the ink after the ink droplet lands on the recording medium. As a result, it is possible to reliably form images with excellent rubfastness. Further, by setting the total content ratio of the first surfactant and the second surfactant to 0.40 mass % or less, it is possible to optimize the surface tension of the ink droplet when the ink according to this embodiment is ejected from the recording head. As a result, it is possible to provide an ink having more excellent flyability.

### [Different Surfactant]

The ink according to this embodiment may include only the first surfactant and the second surfactant as surfactants, but may further include a surfactant other than the first surfactant and the second surfactant (hereinafter, referred to as a different surfactant). In the surfactants, the total content ratio of the first surfactant and the second surfactant is favorably 50.00 mass % or more, more favorably 60.00 mass % or more.

Examples of the different surfactant include an acetylene glycol surfactant (surfactant including an acetylene glycol compound), a silicone surfactant (surfactant including a silicone compound), and a fluorosurfactant (surfactant including a fluoropolymer or a fluorine-containing compound). Examples of the acetylene glycol surfactant include an ethylene oxide adduct of acetylene glycol and a propylene oxide adduct of acetylene glycol.

In the ink according to this embodiment, the content ratio of the different surfactant is favorably 0.05 mass % or more and 0.35 mass % or less, more favorably 0.05 mass % or more and 0.25 mass % or less.

### [Aqueous Medium]

The aqueous medium includes water and a specific organic solvent. The aqueous medium may function as a solvent or a dispersion medium. The aqueous medium may further include a water-soluble organic solvent other than the specific organic solvent (water-soluble organic solvent having Log K_{ow} of less than −1.80 or exceeding −1.00, hereinafter, referred to as a different water-soluble organic solvent in some cases).

In the ink according to this embodiment, the content ratio of the aqueous medium is favorably 75.00 mass % or more and 98.00 mass % or less, more favorably 85.00 mass % or more and 95.00 mass % or less.

In the ink according to this embodiment, the content ratio of water is favorably 40.00 mass % or more and 80.00 mass % or less, more favorably 50.00 mass % or more and 70.00 mass % or less. By setting the content ratio of water to 40.00 mass % or more and 80.00 mass % or less, it is possible to optimize the surface tension of the ink according to this embodiment (particularly, the surface tension of the ink droplet when ejected from the recording head and the surface tension of the ink after the ink droplet lands on the recording medium).

### (Specific Organic Solvent)

The Log K_{ow} of the specific organic solvent is −1.80 or more and −1.00 or less. By setting the Log K_{ow} of the specific organic solvent to −1.80 or more, it is possible to sufficiently reduce the surface tension of the ink after the ink droplet lands on the recording medium. As a result, it is possible to form images with excellent rubfastness. By setting the Log K_{ow} of the specific organic solvent to −1.00 or less, it is possible to form an ink droplet having high surface tension when the ink according to this embodiment is ejected from the recording head. As a result, it is possible to provide an ink having excellent flyability.

Examples of the specific organic solvent includes organic solvents shown in the following Table 1. As the specific organic solvent, glycerin or 1,3-propanediol is favorable.

TABLE 1

| Name | LogK_{ow} |
|---|---|
| Glycerin | −1.76 |
| Triethylene glycol | −1.75 |
| Dipropylene glycol monopropylether | −1.53 |
| Diethylene glycol | −1.47 |
| Triethylene glycol monomethylether | −1.46 |
| Ethylene glycol | −1.36 |
| Propylene glycol monobutylether | −1.36 |
| Tripropylene glycol monomethylether | −1.24 |
| Diethylene glycolbutylmethylether | −1.20 |
| Diethylene glycol monomethylether | −1.18 |
| 1,3-propanediol | −1.04 |

In the ink according to this embodiment, the content ratio of the specific organic solvent is favorably 15.00 mass % or more and 45.00 mass % or less, more favorably 25.00 mass % or more and 35.00 mass % or less. By setting the content ratio of the specific organic solvent to 15.00 mass % or more, it is possible to optimize the flyability of the ink according to this embodiment. By setting the content ratio of the specific organic solvent to 40.00 mass % or less, the ink according to this embodiment is capable of forming images with more excellent rubfastness.

### (Different Water-Soluble Organic Solvent)

Examples of the different water-soluble organic solvent include a glycol compound, a glycolether compound, a lactam compound, a nitrogen-containing compound, an acetate compound, thiodiglycol, and dimethylsulfoxide.

In the aqueous medium, the content ratio of the different water-soluble organic solvent is favorably 10.00 mass % or less, more favorably 1.00 mass % or less, and still more favorably 0.00 mass %.

### [Other Components]

The ink according to this embodiment may further include, as necessary, known additives (e.g., a dissolution stabilizer, an anti-drying agent, an antioxidant, a viscosity adjustor, a pH adjuster, and an antifungal agent).

### [Favorable Composition]

The ink according to this embodiment favorably has one of compositions 1 to 10 shown in the following Tables 2 and 3. Note that in the following Tables 2 and 3, the “ratio” represents a numerical range of a favorable content ratio [mass %]. For example, “5.10-6.30” that is the ratio of the pigment in the composition 1 indicates that 5.10 mass % or more and 6.30 mass % or less of the pigment is included. “A-1”, “A-2”, “A-3”, and “A-4” in the type of first surfactant respectively indicate surfactants (A-1), (A-2), (A-3), and (A-4) used in Examples. “B-1” and “B-2” in the type of second surfactant respectively indicate surfactants (B-1) and (B-2) used in Examples. “GL” indicates glycerin. “1,3-PD” indicates 1,3-propanediol.

TABLE 2

| | | Composition | | | | |
|---|---|---|---|---|---|---|
| | | 1 | 2 | 3 | 4 | 5 |
| Pigment | Ratio | 5.10-6.30 | 5.10-6.30 | 5.10-6.30 | 5.10-6.30 | 5.10-6.30 |
| Pigment | Ratio | 2.10-2.50 | 2.10-2.50 | 2.10-2.50 | 2.10-2.50 | 2.10-2.50 |
| coating | | | | | | |
| resin | | | | | | |
| First | Type | A-1 | A-1 | A-2 | A-2 | A-1 |
| surfactant | Ratio | 0.09-0.11 | 0.09-0.11 | 0.09-0.11 | 0.09-0.11 | 0.24-0.30 |
| Second | Type | B-1 | B-2 | B-1 | B-2 | B-1 |
| surfactant | Ratio | 0.09-0.11 | 0.09-0.11 | 0.09-0.11 | 0.09-0.11 | 0.09-0.11 |
| Different | Ratio | 0.17-0.21 | 0.17-0.21 | 0.17-0.21 | 0.17-0.21 | 0.17-0.21 |
| surfactant | | | | | | |
| Specific | Type | GL | 1,3-PD | GL | 1,3-PD | GL |
| organic | Ratio | 27.00-33.00 | 27.00-33.00 | 27.00-33.00 | 27.00-33.00 | 27.00-33.00 |
| solvent | | | | | | |
| Water | Ratio | Remaining | Remaining | Remaining | Remaining | Remaining |
| | | amount | amount | amount | amount | amount |

TABLE 3

| | | Composition | | | | |
|---|---|---|---|---|---|---|
| | | 6 | 7 | 8 | 9 | 10 |
| Pigment | Ratio | 5.10-6.30 | 5.10-6.30 | 5.10-6.30 | 5.10-6.30 | 5.10-6.30 |
| Pigment | Ratio | 2.10-2.50 | 2.10-2.50 | 2.10-2.50 | 2.10-2.50 | 2.10-2.50 |
| coating | | | | | | |
| resin | | | | | | |
| First | Type | A-1 | A-1 | A-1 | A-3 | A-4 |
| surfactant | Ratio | 0.09-0.11 | 0.09-0.11 | 0.09-0.11 | 0.09-0.11 | 0.09-0.11 |
| Second | Type | B-1 | B-1 | B-1 | B-1 | B-1 |
| surfactant | Ratio | 0.18-0.22 | 0.09-0.11 | 0.09-0.11 | 0.09-0.11 | 0.09-0.11 |
| Different | Ratio | 0.17-0.21 | 0.17-0.21 | 0.17-0.21 | 0.17-0.21 | 0.17-0.21 |
| surfactant | | | | | | |
| Specific | Type | GL | GL | GL | GL | GL |
| organic | Ratio | 27.00-33.00 | 19.80-24.20 | 34.20-41.80 | 27.00-33.00 | 27.00-33.00 |
| solvent | | | | | | |
| Water | Ratio | Remaining | Remaining | Remaining | Remaining | Remaining |
| | | amount | amount | amount | amount | amount |

### [Method of Producing Ink]

The ink according to this embodiment can be produced by, for example, uniformly mixing a pigment dispersion liquid including a pigment, a first surfactant, a second surfactant, and an aqueous medium using a stirrer. In the production of the ink according to this embodiment, after uniformly mixing each component, foreign substances and coarse particles may be removed by a filter (e.g., a filter having a pore size of 5 μm or less).

### (Pigment Dispersion Liquid)

The pigment dispersion liquid is a dispersion liquid including a pigment. The pigment dispersion liquid favorably further includes a pigment coating resin. As the dispersion medium of the pigment dispersion liquid, water is favorable.

The content ratio of the pigment in the pigment dispersion liquid is favorably 5.00 mass % or more and 30.00 mass % or less, more favorably 10.00 mass % or more and 20.00 mass % or less. The content ratio of the pigment coating resin in the pigment dispersion liquid is favorably 2.00 mass % or more and 10.00 mass % or less, more favorably 5.00 mass % or more and 7.00 mass % or less.

The pigment dispersion liquid can be prepared by wet dispersing a pigment, a pigment coating resin, a dispersion medium (e.g., water), and a component added as necessary (e.g., a different surfactant) using a media-type wet disperser. In the wet dispersing using a media-type wet disperser, for example, small beads (e.g., beads having D₅₀ of 0.5 mm or more and 1.0 mm or less) can be used as media. The material of the beads is not particularly limited, but a hard material (e.g., glass and zirconia) is favorable.

Examples of the present disclosure will be described below. However, the present disclosure is not limited to the following Examples.

### [Preparation of First Surfactant]

Surfactants (A-1) to (A-4) and (S-1) shown in the following Table 4 were prepared as first surfactants. In the product name shown in the following Table 4, “(R)” represents registered trademark. Of the surfactants (A-1) to (A-4) and (S-1), the surfactants (A-1) to (A-4) were each the compound represented by the general formula (I). The surfactant (S-1) was an acetylene glycol surfactant. In the following Table 4, the numerical values of m+n, x, and y in the general formula (I) are described for the surfactants (A-1) to (A-4) and (S-1).

TABLE 4

| | m + n | x | y | Manufacturer | Product name |
|---|---|---|---|---|---|
| A-1 | 10.0 | 7.0 | 2.5 | NIPPON SHOKUBAI CO., LTD. | SOFTANOL(R)EP7025 |
| A-2 | 10.0 | 12.0 | 3.0 | NIPPON SHOKUBAI CO., LTD. | SOFTANOL(R)EP12030 |
| A-3 | 10.0 | 9.0 | 5.0 | NIPPON SHOKUBAI CO., LTD. | SOFTANOL(R)EP9050 |
| A-4 | 10.0 | 7.0 | 4.5 | NIPPON SHOKUBAI CO., LTD. | SOFTANOL(R)EP7045 |

| | | | |
|---|---|---|---|
| S-1 | Acetylene glycol surfactant | Nissin Chemical co., ltd. | SURFYNOL(R)440 |

### [Preparation of Second Surfactant]

Surfactants (B-1) and (B-2) shown in the following Table 5 and the surfactant (S-1) shown in Table 4 were prepared as second surfactants. In the product name shown in the following Table 5, “(R)” represents registered trademark. The surfactants (B-1) and (B-2) were each the compound represented by the general formula (II). In the following Table 5, the numerical values of m+n and b in the general formula (II) are described for the surfactants (B-1) and (B-2).

TABLE 5

| | a + c | b | Manufacturer | Product name |
|---|---|---|---|---|
| B-1 | 21 | 19 | DKS Co. Ltd. | EPAN(R)450 |
| B-2 | 17 | 23 | DKS Co. Ltd. | EPAN(R)710 |

### [Preparation of Pigment Dispersion Liquid]

A pigment dispersion liquid to be used for preparation of ink was prepared. In the preparation of the pigment dispersion liquid, first, a pigment coating resin solution including the pigment coating resin (R-1) and water was prepared.

### (Preparation of Pigment Coating Resin Solution)

An alkali-soluble resin including a repeating unit derived from methacrylic acid (MAA unit), a repeating unit derived from methyl methacrylate (MMA unit), a repeating unit derived from butyl acrylate (BA unit), and a repeating unit derived from styrene (ST unit) was prepared. In this alkali-soluble resin, the mass average molecular weight (Mw) was 20000 and the acid value was 100 mgKOH/g. The mass ratio of each repeating unit in this alkali-soluble resin was “MAA unit:MMA unit:BA unit:ST unit=40:15:30:15”. This alkali-soluble resin and the aqueous sodium hydroxide solution were mixed (neutralization treatment). The neutralization treatment neutralized the alkali-soluble resin with NaOH. In the neutralization treatment, the amount of the aqueous sodium hydroxide solution used was 1.05 times the theoretical value of the amount of the aqueous sodium hydroxide solution necessary for neutralizing the alkali-soluble resin. In this way, a pigment coating resin solution including the pigment coating resin (R-1) (neutralized alkali-soluble resin) and water was obtained.

The Mw of the above-mentioned alkali-soluble resin was measured using gel permeation chromatography (“HLC-8020GPC” manufactured by TOSOH CORPORATION) under the following conditions. Calibration curves were created using “F-40”, “F-20”, “F-4”, “F-1”, “A-5000”, “A-2500”, and “A-1000”, which are TSKgel standard polystyrene manufactured by TOSOH CORPORATION, and n-propylbenzene.

### (Measurement Conditions for Mass Average Molecular Weight)

Column: “TSKgel SuperMultiporeHZ-H” (semi-microcolumn of 4.6 mm I.D.×15 cm) manufactured by TOSOH CORPORATION
Number of columns: 3
Eluent: tetrahydrofuran
Flow rate: 0.35 mL/min
Sample injection amount: 10 μL
Measurement temperature: 40° C.
Detector: IR detector

### (Dispersion)

A magenta pigment (C.I. Pigment Red 122), the above-mentioned pigment coating resin solution including the pigment coating resin (R-1), “OLFINE (registered trademark) E1010” (ethylene oxide adduct of acetylene glycol) manufactured by Nissin Chemical co.,ltd., which was an acetylene glycol surfactant, and ion exchanged water were added to a vessel of a media-type wet disperser (“DYNO (registered trademark)-MILL” manufactured by Willy A Bachofen AG (WAB)) such that the composition shown in the following Table 6 was obtained.

Note that the content ratio of “water” in the following Table 6 indicates the total content ratio of the above-mentioned ion exchanged water added to the vessel and water contained in the pigment coating resin solution (in detail, water contained in the aqueous sodium hydroxide solution used for neutralizing the alkali-soluble resin and water generated by the neutralization reaction between the alkali-soluble resin and sodium hydroxide).

TABLE 6

| | Content ratio |
|---|---|
| Pigment dispersion liquid | [mass %] |
| Magenta pigment | 15.00 |
| Pigment coating resin (R-1) (neutralized with NaOH) | 6.00 |
| Acetylene glycol surfactant | 0.50 |
| Water | 78.50 |
| Total | 100.00 |

Subsequently, the content of the vessel was wet-dispersed. As media, zirconia beads (particle diameter of 1.0 mm) were used. The amount of added media was set to 70% by volume to the volume of the vessel. The dispersion conditions were a temperature of 10° C. and a circumferential speed of 8 m/sec. In this way, a pigment dispersion liquid was obtained.

The volume median diameter (D₅₀) of the pigment particles included in the obtained pigment dispersion liquid was measured. In detail, the obtained pigment dispersion liquid was diluted 300-fold with ion exchanged water and was used as a measurement sample. D₅₀ of the pigment particles in the measurement sample was measured using a dynamic light scattering particle size distribution analyzer (“Zetasizer (registered trademark) Nano ZS” manufactured by Malvern Panalytical Ltd.). D₅₀ of the pigment particles in the measurement sample was used as D₅₀ of the pigment particles included in the pigment dispersion liquid. Note that the measurement was performed 10 times, and the average value of the measurement results was used as D₅₀ of the pigment particles. D₅₀ of the pigment particles included in the pigment dispersion liquid was 100 nm.

### <Preparation of Ink>

Inks according to Examples 1 to 10 and Comparative Examples 1 to 11 having compositions shown in the following Tables 7 to 10 were prepared by the following method.

### Example 1

38.10 parts by mass of a pigment dispersion liquid (5.71 parts by mass of a pigment, 2.29 parts by mass of a pigment coating resin (R)), a first surfactant shown in the following Table 7 (in Example 1, 0.10 parts by mass of a surfactant (A-1)), a second surfactant shown in the following Table 7 (in Example 1, 0.10 parts by mass of a surfactant (B-1)), an organic solvent shown in the following Table 7 (in Example 1, 30.00 parts by mass of glycerin), and ion exchanged water were added to a beaker. The amount of ion exchanged water used was set to the amount (in Example 1, 31.70 parts by mass) that would make the amount of content in the beaker 100.00 parts by mass. The content of the beaker was mixed at a rotational speed of 400 rpm using a stirrer (“Three-One Motor BL-600” manufactured by Shinto Scientific Co., Ltd.) to obtain a mixed solution. The mixed solution was filtered using a filter (pore size of 5 μm) to remove foreign substances and coarse particles included in the mixed solution. In this way, the ink according to Example 1 was obtained.

### Examples 2 to 10 and Comparative Examples 1 to 11

Inks according to Examples 2 to 10 and Comparative Examples 1 to 11 were prepared in the same way as that for the preparation of the ink according to Example 1 except that the type and amount of each component were changed as shown in Tables 7 to 10. Note that in the following Tables 7 to 10, “GL” indicates glycerin and “1,3-PD” indicates 1,3-propanediol. “PG” indicates propylene glycol and “EBEE” indicates ethylene glycol butylethylether.

TABLE 7

| | | | | | | Comparative | Comparative |
|---|---|---|---|---|---|---|---|
| | | Example 1 | Example 2 | Example 3 | Example 4 | Example 1 | Example 2 |
| First | Type | A-1 | A-1 | A-2 | A-2 | A-1 | A-1 |
| surfactant | m + n | 10.0 | 10.0 | 10.0 | 10.0 | 10.0 | 10.0 |
| | x | 7.0 | 7.0 | 12.0 | 12.0 | 7.0 | 7.0 |
| | y | 2.5 | 2.5 | 3.0 | 3.0 | 2.5 | 2.5 |
| | Mass % | 0.10 | 0.10 | 0.10 | 0.10 | 0.10 | 0.10 |
| Second | Type | B-1 | B-2 | B-1 | B-2 | B-1 | B-2 |
| surfactant | a + c | 21 | 17 | 21 | 17 | 21 | 17 |
| | b | 19 | 23 | 19 | 23 | 19 | 23 |
| | Mass % | 0.10 | 0.10 | 0.10 | 0.10 | 0.10 | 0.10 |
| Organic | Type | GL | 1,3-PD | GL | 1,3-PD | PG | EBEE |
| solvent | LogK_{ow} | −1.76 | −1.04 | −1.76 | −1.04 | −0.92 | −1.88 |
| | Mass % | 30.00 | 30.00 | 30.00 | 30.00 | 30.00 | 30.00 |

TABLE 8

| | | Comparative | Comparative | Comparative | Comparative | Comparative |
|---|---|---|---|---|---|---|
| | | Example 3 | Example 4 | Example 5 | Example 6 | Example 7 |
| First | Type | A-2 | A-2 | S-1 | A-1 | S-1 |
| surfactant | m + n | 10.0 | 10.0 | Acetylene | 10.0 | Acetylene |
| | X | 12.0 | 12.0 | glycol | 7.0 | glycol |
| | Y | 3.0 | 3.0 | surfactant | 2.5 | surfactant |
| | Mass % | 0.10 | 0.10 | 0.10 | 0.10 | 0.50 |
| Second | Type | B-1 | B-2 | B-1 | S-1 | Not used |
| surfactant | a + c | 21 | 17 | 21 | Acetylene | |
| | b | 19 | 23 | 19 | glycol | |
| | | | | | surfactant | |
| | Mass % | 0.10 | 0.10 | 0.10 | 0.10 | |
| Organic | Type | PG | EBEE | GL | GL | GL |
| solvent | LogK_{ow} | −0.92 | −1.88 | −1.76 | −1.76 | −1.76 |
| | Mass % | 30.00 | 30.00 | 30.00 | 30.00 | 30.00 |

TABLE 9

| | | | | Comparative | Comparative | Comparative | Comparative |
|---|---|---|---|---|---|---|---|
| | | Example 5 | Example 6 | Example 8 | Example 9 | Example 10 | Example 11 |
| First | Type | A-1 | A-1 | A-1 | A-1 | Not used | A-1 |
| surfactant | m + n | 10.0 | 10.0 | 10.0 | 10.0 | | 10.0 |
| | X | 7.0 | 7.0 | 7.0 | 7.0 | | 7.0 |
| | Y | 2.5 | 2.5 | 2.5 | 2.5 | | 2.5 |
| | Mass % | 0.27 | 0.10 | 0.40 | 0.10 | | 0.10 |
| Second | Type | B-1 | B-1 | B-1 | B-1 | B-1 | Not used |
| surfactant | a + c | 21 | 21 | 21 | 21 | 21 | |
| | b | 19 | 19 | 19 | 19 | 19 | |
| | Mass % | 0.10 | 0.20 | 0.10 | 0.35 | 0.10 | |
| Organic | Type | GL | GL | GL | GL | GL | GL |
| solvent | LogK_{ow} | −1.76 | −1.76 | −1.76 | −1.76 | −1.76 | −1.76 |
| | Mass % | 30.00 | 30.00 | 30.00 | 30.00 | 30.00 | 30.00 |

TABLE 10

| | | Example 7 | Example 8 | Example 9 | Example 10 |
|---|---|---|---|---|---|
| First | Type | A-1 | A-1 | A-3 | A-4 |
| surfactant | m + n | 10.0 | 10.0 | 10.0 | 10.0 |
| | x | 7.0 | 7.0 | 9.0 | 7.0 |
| | y | 2.5 | 2.5 | 5.0 | 4.5 |
| | Mass % | 0.10 | 0.10 | 0.10 | 0.10 |
| Second | Type | B-1 | B-1 | B-1 | B-1 |
| surfactant | a + c | 21 | 21 | 21 | 21 |
| | b | 19 | 19 | 19 | 19 |
| | Mass % | 0.10 | 0.10 | 0.10 | 0.10 |
| Organic | Type | GL | GL | GL | GL |
| solvent | LogK_{ow} | −1.76 | −1.76 | −1.76 | −1.76 |
| | Mass % | 22.00 | 38.00 | 30.00 | 30.00 |

### [Measurement of Dynamic Surface Tension]

The dynamic surface tension at the surface age of 10 ms and the dynamic surface tension at the surface age of 1000 ms of the ink according to each of Examples and Comparative Examples were measured at 25° C. by a maximum bubble pressure method using a bubble pressure dynamic surface tensiometer (“BP100” manufactured by KRUSS GmbH, capillary diameter of 0.4 mm). The measurement results are shown in the following Table 11.

### [Evaluation]

The flyability of the ink (the ability of the ink droplet to remain together when the ink is ejected) and the rubfastness of a formed image were evaluated by the following method for the ink according to each of Examples and Comparative Examples. The evaluation results are shown in the following Table 11. Note that the evaluation was performed at a temperature of 25° C. and a humidity of 15% RH, unless otherwise specified.

### [Evaluation Device]

A line-head inkjet recording apparatus (tester manufactured by KYOCERA Document Solutions Inc.) was used as an evaluation device. The evaluation device included a piezoelectric recording head. The recording head was set such that the head temperature was 32° C. and the ejection speed of the ink was 8 m/sec. The recording head was filled with the ink to be evaluated (in detail, one of the inks according to Examples and Comparative Examples).

### [Flyability]

In the valuation of flyability, the ink to be evaluated was ejected from the recording head of the evaluation device. The ink droplet during ejection was imaged using a high-speed camera (“Hyper Vision HPV-X2” manufactured by SHIMADZU CORPORATION). The length of the tail was calculated on the basis of the length from the rear end of the main droplet of the imaged ink droplet to the rear end of the tail. The ink droplet with a long tail tends to generate a satellite droplet when the tail is torn off during flight. For this reason, the length of the tail can be used as a reference of the flyability of the ink. The flyability of the ink was judged on the basis of the length of the tail in accordance with the following criteria.

### (Evaluation of Flyability)

A (Good): the length of the tail is less than 0.31 mm.
B (Poor): the length of the tail is 0.31 mm or more.

### [Rubfastness]

In the evaluation of rubfastness, copy paper (“CC90” manufactured by Mondi plc) was used as a recording medium. In the evaluation of rubfastness, the volume per drop of the ink ejected from the recording head of the evaluation device was set to 11.5 pL (the ink amount of 11.5 pL per pixel). A solid image (size: 5 cm×4 cm) was formed on the recording medium using the evaluation device. Next, an unused recording medium (evaluation paper) was placed on top of the recording medium on which the solid image was formed. Next, a weight of 1 kg with the base area of 5 cm×4 cm was placed on the evaluation paper. At this time, the weight was placed such that the center of gravity of the weight was located at the center of the solid image. Next, the solid image was rubbed against the evaluation paper by holding both ends of the evaluation paper with the weight thereon (weight of 1 kg) and causing the evaluation paper to move back and forth five times in the horizontal direction.

Next, the image density of the stained image transferred from the solid image to the evaluation paper was measured using a reflection densitometer (“FD-9” manufactured by Konica Minolta, Inc.) (Observation light source: D₅₀ light source, illumination conditions: M2, a field of view: 2°, a density status: I). In detail, the image density at 10 positions randomly selected from the stained image was measured using the reflection densitometer to calculate an arithmetic mean value (ID value) of the image densities at the 10 positions. Next, the image density of unused copy paper (“CC90” manufactured by Mondi plc) instead of the evaluation paper was measured in the same manner as that for the ID value, and the obtained value was used as a “background value”. The value obtained by subtracting the background value from the ID value was used as the evaluation value (FD value) of rubfastness (FD value=ID value−the background value). The rubfastness was judged in accordance with the following criteria.

### (Criteria for Rubfastness)

Good (A): the FD value is less than 0.020.
Poor (B): the FD value is 0.020 or more.

TABLE 11

| | Dynamic surface | | Flyability | | | |
|---|---|---|---|---|---|---|
| | tension[mN/m] | | Tail | | Rubfastness | |
| | 10 ms | 1000 ms | length[mm] | Judgement | FD | Judgement |
| Example 1 | 45 | 37 | 0.23 | A | 0.013 | A |
| Example 2 | 39 | 35 | 0.30 | A | 0.007 | A |
| Example 3 | 47 | 37 | 0.24 | A | 0.015 | A |
| Example 4 | 44 | 36 | 0.26 | A | 0.008 | A |
| Comparative | 36 | 35 | 0.36 | B | 0.006 | A |
| Example 1 | | | | | | |
| Comparative | 54 | 39 | 0.25 | A | 0.024 | B |
| Example 2 | | | | | | |
| Comparative | 37 | 36 | 0.32 | B | 0.011 | A |
| Example 3 | | | | | | |
| Comparative | 55 | 43 | 0.16 | A | 0.025 | B |
| Example 4 | | | | | | |
| Comparative | 52 | 39 | 0.22 | A | 0.022 | B |
| Example 5 | | | | | | |
| Comparative | 54 | 40 | 0.18 | A | 0.025 | B |
| Example 6 | | | | | | |
| Comparative | 57 | 42 | 0.14 | A | 0.027 | B |
| Example 7 | | | | | | |
| Example 5 | 41 | 36 | 0.27 | A | 0.010 | A |
| Example 6 | 39 | 35 | 0.29 | A | 0.008 | A |
| Comparative | 35 | 34 | 0.38 | B | 0.006 | A |
| Example 8 | | | | | | |
| Comparative | 34 | 32 | 0.35 | B | 0.005 | A |
| Example 9 | | | | | | |
| Comparative | 53 | 39 | 0.25 | A | 0.026 | B |
| Example 10 | | | | | | |
| Comparative | 55 | 42 | 0.17 | A | 0.027 | B |
| Example 11 | | | | | | |
| Example 7 | 41 | 35 | 0.28 | A | 0.017 | A |
| Example 8 | 48 | 37 | 0.17 | A | 0.009 | A |
| Example 9 | 42 | 34 | 0.25 | A | 0.010 | A |
| Example 10 | 40 | 33 | 0.27 | A | 0.009 | A |

As shown in Tables 4 to 11, the ink according to each of Examples included a pigment, a first surfactant, a second surfactant, and an aqueous medium. The first surfactant was the compound represented by the general formula (I). The second surfactant was the compound represented by the general formula (II). The aqueous medium included water and a specific organic solvent. The octanol/water partition coefficient Log K_{ow} of the specific organic solvent was −1.80 or more and −1.00 or less. In the ink according to each of Examples, the content ratio of the first surfactant was 0.03 mass % or more and 0.35 mass % or less and the content ratio of the second surfactant was 0.03 mass % or more and 0.30 mass % or less. In the ink according to each of Examples, the evaluation results of the flyability and the rubfastness of a formed image were good.

On the other hand, the inks according to Comparative Examples 1 and 3 did not include a specific organic solvent but included propylene glycol that had the octanol/water partition coefficient Log K_{ow} higher than −1.00 and a relatively high hydrophobicity. The inks according to Comparative Example 1 and 3 had excessively low dynamic surface tension at the surface age of 10 ms due to propylene glycol. As a result, in the inks according to Comparative Example 1 and 3, the evaluation result of the flyability was poor.

The inks according to Comparative Examples 2 and 4 did not include a specific organic solvent but included ethylene glycolbutylethylether that had the octanol/water partition coefficient Log K_{ow} lower than −1.80 and relatively high hydrophilicity. In the inks according to Comparative Examples 2 and 4, the dynamic surface tension at the surface age of 1000 ms was excessively high due to ethylene glycolbutylethylether. As a result, in the inks according to Comparative Examples 2 and 4, the evaluation result of the rubfastness of a formed image was poor.

The inks according to Comparative Examples 5 to 7 did not include, as a surfactant, at least one of the compound represented by the general formula (I) or the compound represented by the general formula (II) but included an acetylene glycol surfactant. Although the ink according to Comparative Examples 5 to 7 included a surfactant, the dynamic surface tension at the surface age of 1000 ms could not be reduced to a desired range. As a result, in the inks according to Comparative Examples 5 to 7, the evaluation result of the rubfastness of a formed image was poor.

The inks according to Comparative Examples 8 and 9 included, as surfactants, the compound represented by the general formula (I) and the compound represented by the general formula (II). However, in the inks according to Comparative Examples 8 and 9, the content ratio of the compound represented by the general formula (I) or the compound represented by the general formula (II) was excessively large. As a result, in the inks according to Comparative Examples 8 and 9, the evaluation result of the flyability was poor.

The inks according to Comparative Examples 10 and 11 used only one type of surfactant and included, as a surfactant, only one of the compound represented by the general formula (I) and the compound represented by the general formula (II). For this reason, in the inks according to Comparative Examples 10 and 11, the dynamic surface tension at the surface age of 1000 ms could not be reduced to a desired range. As a result, in the inks according to Comparative Examples 10 and 11, the evaluation result of the rubfastness of a formed image was poor.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a first surfactant;
a second surfactant; an
an aqueous medium,
the first surfactant being a compound represented by the following general formula (I),
the second surfactant being a compound represented by the following general formula (II),
the aqueous medium including water and a specific organic solvent,
an octanol/water partition coefficient Log K_{ow} of the specific organic solvent being −1.80 or more and −1.00 or less,
a content ratio of the first surfactant being 0.03 mass % or more and 0.35 mass % or less,
a content ratio of the second surfactant being 0.03 mass % or more and 0.30 mass % or less; 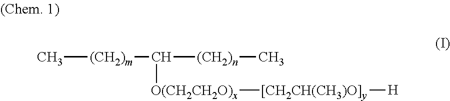
wherein in the general formula (I), m and n each independently represent a number of 0.0 or more and 11.0 or less, m+n is 9.0 or more and 11.0 or less, x represents a number of 1.0 or more and 20.0 or less, and y represents a number of 1.0 or more and 10.0 or less; 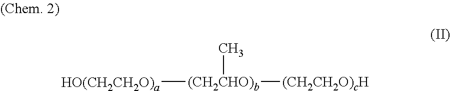
wherein in the general formula (II), a and c each independently represents a number of 0 or more and 25 or less, a+c is 13 or more and 25 or less, and
b represents a number of 15 or more and 27 or less.

2. The inkjet ink according to claim 1, wherein
at a temperature of 25° C.,
dynamic surface tension at a surface age of 10 ms is 38 mN/m or more and 50 mN/m or less, and
dynamic surface tension at a surface age of 1000 ms is 30 mN/m or more and 38 mN/m or less.

3. The inkjet ink according to claim 1, wherein
a content ratio of the specific organic solvent is 15.00 mass % or more and 45.00 mass % or less.

4. The inkjet ink according to claim 1, wherein
in the general formula (I),
x represents a number of 6.0 or more and 13.0 or less, and
y represents a number of 1.5 or more and 6.0 or less.

5. The inkjet ink according to claim 1, wherein
in the general formula (II),
a+c is 16 or more and 22 or less, and
b represents a number of 18 or more and 24 or less.

6. The inkjet ink according to claim 1, wherein
the specific organic solvent includes at least one of glycerin or 1,3-propanediol.
